(19) United States
(12) Patent Application Publication
(10) Pub. No.: US 2011/0181265 A1
(43) Pub. Date: Jul. 28, 2011

(54) DC/DC CONVERTER CIRCUIT

(75) Inventors: Masahiko HIRAYAMA, Kanagawa (JP); Hisashi MORI, Kanagawa (JP)

(73) Assignee: Renesas Electronics Corporation

(21) Appl. No.: 13/006,093

(22) Filed: Jan. 13, 2011

(30) Foreign Application Priority Data
Jan. 25, 2010 (JP) 2010-013095

(51) Int. Cl. G05F 1/46

(52) U.S. Cl. 323/288

(57) ABSTRACT

A charging pump circuit of discharging electric charge charged during charging period to load during boosting period, and an amplifier and a voltage control resistor element arranged in feedback loop by being configured with the feedback loop of feeding back output voltage such that the output voltage of the charging pump circuit is made to be a predetermined value during boosting period are provided, the voltage control resistor element is controlled by the amplifier, and set to a control resistance value of enabling the charging pump circuit to control during boosting period, and the amplifier controls the voltage control resistor element such that the voltage control resistor element is brought into OFF state during charging period, and a resistance value of the voltage control resistor element is lowered to a control resistance value immediately after shifting from charging period to boosting period.

### Cross-reference to related applications

The disclosure of Japanese Patent Application No. 2010-13095 filed on Jan. 25, 2010 including the specification, drawings and abstract is incorporated herein by reference in its entirety.

### BACKGROUND

1. Field of the Invention

The present invention relates to a DC/DC converter circuit, particularly relates to a DC/DC converter circuit stabilizing an output voltage by using a charging pump circuit.

2. Description of Related Art

In a portable device represented by a portable telephone, PDA (personal Digital Assistant: portable information terminal), DSC (Digital Still Camera: digital camera) or the like, a DC/DC converter circuit is frequently used as a power source circuit for generating a negative power source voltage around −2 V, or a positive power source voltage around +5 V which is needed for liquid crystal display driving, by converting a power source voltage of about 3 V. Although there are present various types in a DC/DC converter circuit, particularly, a type of using a charging pump circuit is frequently adopted in a portable device since a total volume of necessary parts is small.

FIG. 8 is a circuit diagram of a DC/DC converter circuit of a voltage inverting type described in Japanese Unexamined Patent Publication No. 2005-312169. Further, although in Japanese Unexamined Patent Publication No. 2005-312169, the DC/DC converter circuit per se is referred to as a charging pump circuit, in the following description, numeral 23 of FIG. 8 designates a charging pump circuit in a narrow sense. The DC/DC converter circuit of the voltage inverting type is a circuit with an object of generating a voltage lower than a ground potential. In FIG. 8, the voltage inverting type DC/DC converter circuit is provided with the charging pump circuit 23 including a capacitor C1 for charging, a capacitor C2 for outputting, and 4 switches SW1 through SW4, and a voltage regulation circuit 10. The charging pump circuit 23 makes a so-to-speak voltage inverting type charging pump circuit of inverting a polarity of an input voltage Vin to output as Vout ==Vin. The switch SW1 and the switch SW2 are respectively coupled to both ends of the capacitor C1, the switch SW1 is coupled to an input voltage side (Vin), and the switch SW2 is coupled to a fixed voltage side (GND). When the switches SW1 and SW2 are made ON, the voltage Vin is applied to the both ends of the capacitor C1 to thereby charge the capacitor C1. In the switch SW3, one end thereof is coupled to a side of the switch SW1 of the capacitor C1, and other end thereof is coupled to a drain terminal of an MOSFET14 of Nch which is a voltage control element of the voltage regulation circuit 10. The switch SW4 is inserted between the capacitors C1 and C2 for coupling, or cutting off the capacitor C1 and the capacitor C2 by being made ON or OFF.

The voltage regulation circuit 10 is a circuit of stabilizing the output voltage Vout by comparing the output voltage Vout and a reference voltage Vref, and is provided with resistors R1, and R2, an operational amplifier 12 and the MOSFET14. In the resistor R1, one end thereof is inputted with the reference voltage Vref, and other end thereof is coupled to a noninverting input terminal of the operational amplifier 12. In the resistor R2, one end thereof is inputted with the output voltage Vout, and other end thereof is coupled to the noninverting input terminal of the operational amplifier 12. An inverting input terminal of the operational amplifier 12 is grounded, and an output terminal of the operational amplifier 12 is coupled to a gate terminal of the MOSFET14. The MOSFET14 is inserted between the switch SW3 and the ground, and is present at a charging/discharging path of the capacitor C2 when the switch SW3 is made ON. Therefore, the MOSFET14 can control an electric charge amount of the capacitor C2 by controlling a gate voltage thereof, as a result thereof, has a function of controlling the output voltage Vout.

Next, an explanation will be given of an operation of the DC/DC converter circuit configured as described above. During a first period, the switch SW1 and the switch SW2 are made ON, and the switch SW3 and the switch SW4 are made OFF. During the time period, the capacitor C1 is charged to the input voltage Vin. On the other hand, during the time period, the capacitor C2 is separated from the capacitor C1, and when a power is supplied to a load circuit 16, the output voltage Vout gradually rises from a desired voltage.

Hence, during a second period, the switch SW1 and the switch SW2 are made OFF, and the switch SW3 and the switch SW4 are made ON. During the second period, an electric charge accumulated at the capacitor C1 is transferred to the capacitor C2 via the SW4, and charges the capacitor C2 until the output voltage Vout which has risen by supplying the power to the load circuit 16 becomes a desired output voltage again. The voltage inverting type charging pump circuit continues supplying the electric charge to the capacitor C2 by alternately repeating the first period and the second period to provide a negative voltage as the output voltage Vout. Now, in a case where the load circuit 16 stays constant, and also the input voltage Vin stays constant, the constant negative voltage can be outputted in a steady state by repeating the first period and the second period as described above. However, when either of the load circuit 16 or the input voltage Vin is changed, the output voltage Vout is varied. Hence, the voltage regulation circuit 10 monitors the output voltage Vout, and controls the MOSFET14 by subjecting the gate terminal of the MOSFET14 which is the voltage control element to a feedback operation such that a relationship shown in Equation (1) described below is established between Vout and Vref. Vout=−R2/R1×Vref . . . Equation (1)

Subjecting the gate voltage of the MOSFET14 to the feedback operation changes a voltage Vgs between the gate and the source of the MOSFET14, and controls a channel resistance. The channel resistance of the MOSFET14 can control the transfer of the electric charge between the capacitor C1 and the capacitor C2 during the second period, and the output voltage Vout can always be stabilized to be a desired voltage by the feedback operation.

### SUMMARY

The following analysis is provided in the present invention.

FIG. 9 shows an example of a timing chart describing an operation of the DC/DC converter circuit shown in FIG. 8. Further, hereinafter, the input voltage Vin is defined as a power source voltage VDD. FIG. 9 shows an example of showing the output voltage Vout, the voltage at the point N1 of coupling the switch SW2 and the capacitor C1, and a change in an impedance of the MOSFET14 during the first period (in correspondence with a charging period) and the second period (in correspondence with a boosting period) as waveforms and setting respective constants to values described below.

### R1=1 MΩ

### R2=2 MΩ

### Vin=VDD=3 V

### Vref=1 V

### Vout=−1 x Vref x R2/R2=−2 V

An explanation will be given here of an operation of a voltage inverting type DC/DC converter circuit of a background art in a case where the output voltage Vout is shifted from the boosting period to the charging period by a value of −2 V which is the set voltage.

First, during the charging period, the power source voltage VDD is charged to the capacitor C1 by making the switches SW1 and SW2 ON, and a feedback loop is cut by making the switches SW3 and SW4 OFF. The voltage accumulated at the capacitor C2 is discharged by the load circuit 16, and therefore, the output voltage Vout rises from −2 V which is the set voltage. The operation amplifier 12 is operated to make the voltage of the output voltage Vout fall when the rising voltage of the output voltage Vout is detected, and therefore, and the impedance of the MOSFET14 is made to be as low as possible to be about 0 Ω.

Next, when shifted to the boosting period, the switches SW1 and SW2 are made OFF, the switches SW3 and SW4 are made ON, the capacitor C2 is charged by a voltage of adding the voltage at the point of coupling the switch SW1 and the capacitor C1 to a voltage of inverting the power source voltage VDD accumulated at the capacitor C1. In this case, immediately after shifting from the charging period to the boosting period, the impedance of the MOSFET14 is about 0 Ω, and therefore, the voltage at the point of coupling the switch SW1 and the capacitor C1 is at a GND potential. Therefore, immediately after shifting from the charging period to the boosting period, the voltage at the point N1 of coupling the switch SW2 and the capacitor C1 which is the voltage of charging the capacitor C2 becomes −3 V which is −1×VDD of inverting the power source VDD voltage accumulated at the capacitor C1. Further, an electric charge having an electric potential of −1×VDD generated at the coupling point N1 charges the capacitor C2 by passing through the switch SW4 to thereby generate the output voltage Vout. Therefore, an overshooting voltage which is lower than −2 V of the set voltage and near to −3 V is generated at the output voltage Vout. The operational amplifier 12 controls the output voltage Vout which has become excessively low to rise. Inherently, the operational amplifier 12 reduces an open gain at a high frequency region, and lowers a cutoff frequency to, for example, about 100 KHz for a countermeasure against an oscillation in using a feedback loop circuit. Therefore, a transient response speed is slow, and the overshooting of the output voltage Vout immediately after shifting from the charging period to the boosting period cannot be prevented.

During the boosting period thereafter, the operational amplifier 12 controls the output voltage Vout to the set voltage by increasing the resistance value of the MOSFET14 by taking time in accordance with a transient response function thereof.

In this way, according to the voltage inverting type DC/DC converter circuit of the background art, regardless of the set voltage of the output voltage Vout shown in Equation (1), at every time immediately after switching from the charging period to the boosting period, −1×VDD which is a polarity inverting voltage inherent to the charging pump circuit 23 is transiently generated at the point N1 of coupling the switch SW2 and the capacitor C1. Therefore, it is necessary to design the switches SW2 and SW4 connected to the output Vout by elements having a withstand voltage of −1×VDD. In this case, in a semiconductor element, the higher the withstand voltage, the larger the area over LSI, also a fabricating step becomes complicated, and a fabricating cost is increased.

According to an aspect of the present invention, a DC/DC converter circuit includes a charging pump circuit of discharging an electric charge charged during a charging period to a load during a boosting period, an amplifier and a voltage control resistor element arranged in a feedback loop by being configured with the feedback loop of feeding back an output voltage such that the output voltage of the charging pump circuit is made to be a predetermined value during the boosting period, the voltage control resistor element is controlled by the amplifier to a control resistance value which is made to be able to control the charging pump circuit during the boosting period, the amplifier brings the voltage control resistance element into an OFF state during the charging period, and controls the voltage control resistance element such that the resistance value of the voltage control resistor element is made to fall to the control resistance value immediately after shifting from the charging period to the boosting period.

According to the present invention, immediately after shifting from the charging period to the boosting period, the polarity inverting voltage or the rising voltage inherent to the charging pump circuit exceeding an output setting voltage is not applied to a switch connected to an output of the charging pump circuit. Therefore, a withstand voltage of a transistor constituting a switch coupled to the output of the charging pump circuit can be made to be a voltage which is lower than the polarity inverting voltage or the rising voltage inherent to the charging pump circuit, and a fabricating cost of a semiconductor device can be reduced.

### BRIEF DESCRIPTION OF THE DRAWINGS

FIG. 1 is a circuit diagram of a DC/DC converter circuit according to a first embodiment of the present invention;

FIG. 2 is a diagram showing waveforms of respective portions of the DC/DC converter circuit according to the first embodiment of the present invention;

FIG. 3 is a circuit diagram of a DC/DC converter circuit according to a second embodiment of the present invention;

FIG. 4 is a circuit diagram of an amplifier according to the second embodiment of the present invention;

FIG. 5 is a circuit diagram of a DC/DC converter circuit according to a third embodiment of the present invention;

FIG. 6 is a diagram showing waveforms of respective portions of the DC/DC converter circuit according to the third embodiment of the present invention;

FIG. 7 is a circuit diagram of a DC/DC converter circuit according to a fourth embodiment of the present invention;

FIG. 8 is a circuit diagram of a DC/DC converter circuit of a background art; and

FIG. 9 is a diagram showing examples of waveforms of respective portions of the DC/DC converter circuit of the background art.

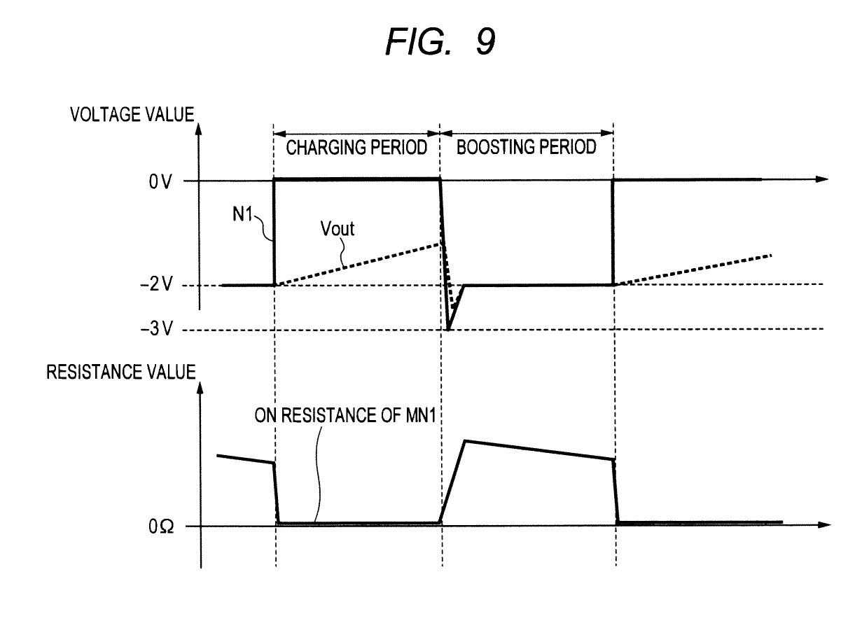

### DETAILED DESCRIPTION OF THE PREFERRED EMBODIMENTS

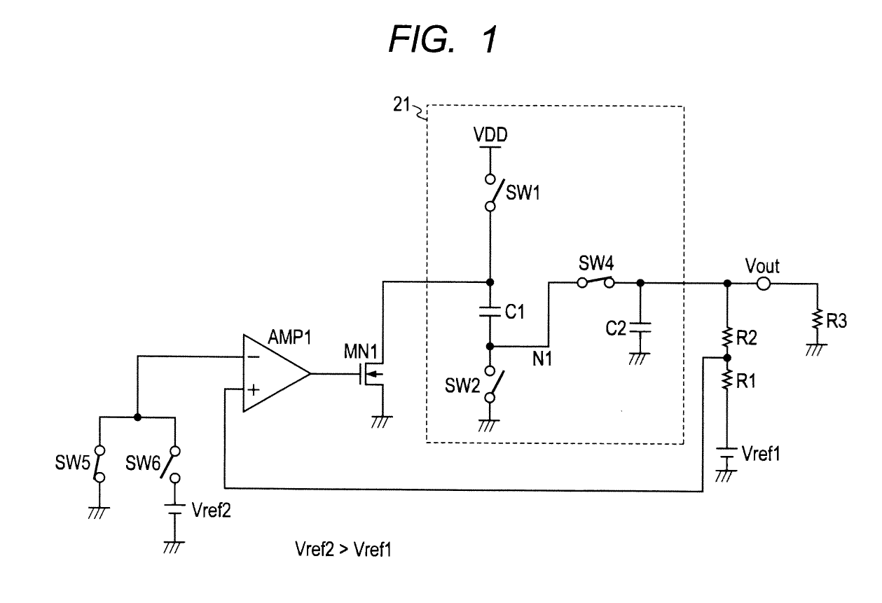

A DC/DC converter circuit according to an embodiment of the present invention includes a charging pump circuit (designated by numeral 21 of FIG. 1) of discharging an electric charge charged during a charging period to a load during a boosting period, and an amplifier (designated by notation AMP1 of FIG. 1) and a voltage control resistor element (designated by notation MN1 of FIG. 1) arranged in a feedback loop by being configured with the feedback loop of feeding back an output voltage such that the output voltage of the charging pump circuit is made to be a predetermined value during the boosting period, the voltage control resistor element is controlled by the amplifier, set to a control resistance value enabling to control the charging pump circuit during the boosting period, the amplifier brings the voltage control resistor element into an OFF state during the charging period, and the voltage control resistor element is controlled such that a resistance value of the voltage control resistor element is lowered to the control resistance value immediately after shifting from the charging period to the boosting period.

It may be configured that in the DC/DC converter circuit, the voltage control resistor element is an MOSFET, the amplifier couples an output terminal thereof to a gate of the MOSFET, and enables the output terminal to set to a predetermined potential such that the MOSFET is brought into an OFF state during the charging period.

It may be configured that in the DC/DC converter circuit, the amplifier is a differential amplifier, and a potential difference is provided between an inverting input terminal and a noninverting input terminal of the differential amplifier during the charging period.

It may be configured that in the DC/DC converter circuit, the MOSFET is an NMOSFET of grounding a source thereof and coupling a drain thereof to the charging pump circuit, 2 pieces of resistor elements (designated by notations R1, R2 of FIG. 1) of coupling a load and a first reference voltage source in a serial mode are provided, the noninverting input terminal of the differential amplifier is coupled to a point of coupling 2 pieces of the resistor elements, and the DC/DC converter circuit is provided with a switching circuit (designated by notations SW5, SW6 of FIG. 1) of coupling the inverting input terminal of the differential amplifier to a second reference voltage source having a reference voltage higher than a reference voltage of the first reference voltage source during the charging period, and grounding the inverting input terminal during the boosting period.

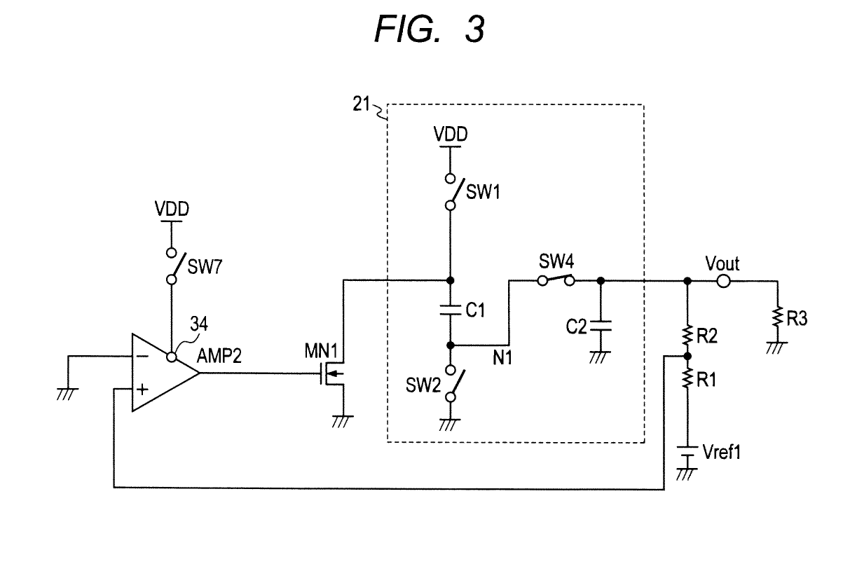

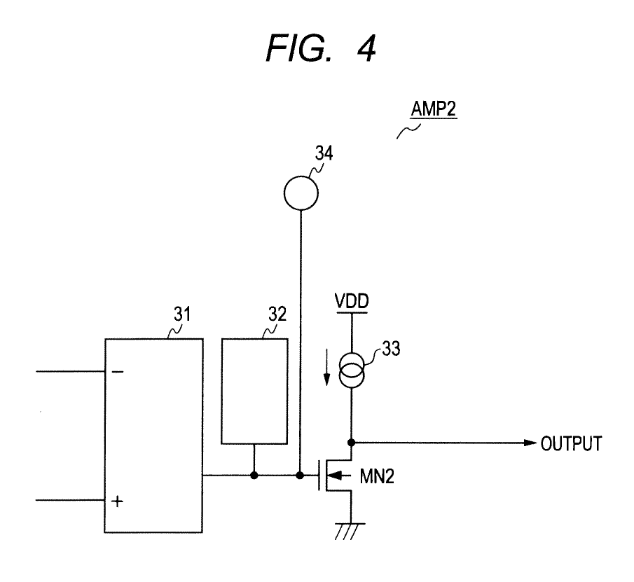

It may be configured that in the DC/DC converter circuit, the MOSFET is an NMOSFET of grounding a source thereof and coupling a drain thereof to the charging pump circuit, 2 pieces of resistor elements of coupling a load and a first reference voltage source in a serial mode are provided, the amplifier is the differential amplifier, a noninverting input terminal of the differential amplifier is coupled to a point of coupling 2 pieces of the resistor elements, an inverting input terminal of the differential amplifier is grounded, and the DC/DC converter circuit is provided with a switching circuit (designated by notation SW7 of FIG. 3) of making an output stage NMOS transistor (MN2 of FIG. 4) ON such that the NMOSFET is brought into an OFF state during the charging period.

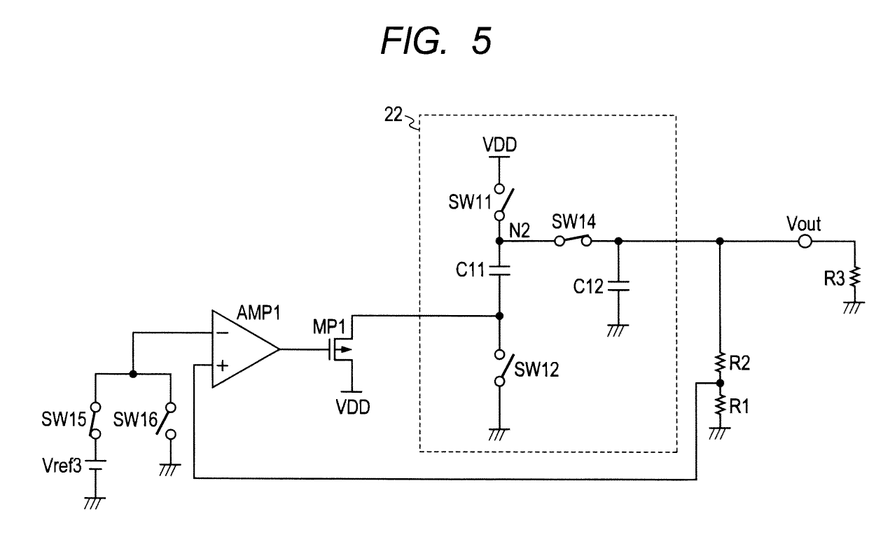

It may be configured that in the DC/DC converter circuit, the MOSFET is a PMOSFET (designated by notation MP1 of FIG. 5) of coupling a source thereof to a power source, and coupling a drain thereof to the charging pump circuit, 2 pieces of resistor elements of coupling a load and the ground in a serial mode are provided, the noninverting input terminal of the differential amplifier is coupled to a point of coupling 2 pieces of the resistor elements, and the DC/DC converter circuit is provided with a switching circuit (designated by notations SW15, SW16 of FIG. 5) of grounding the inverting input terminal of the differential amplifier during the charging period and coupling the inverting input terminal to a third reference voltage source during the charging period.

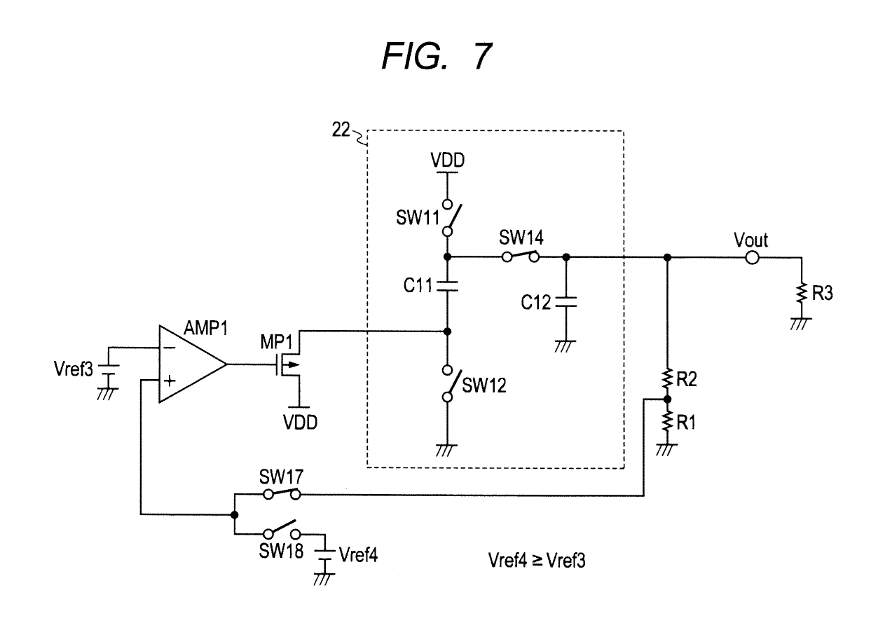

It may be configured that in the DC/DC converter circuit, the MOSFET is a PMOSFET of coupling a source thereof to a power source, and coupling a drain thereof to the charging pump circuit, 2 pieces of resistor elements of coupling a load and the ground in a serial mode are provided, the inverting input terminal of the differential amplifier is coupled to a third reference voltage source, and the DC/DC converter circuit is provided with a switching circuit (designated by notations SW17, SW18 of FIG. 7) of coupling the noninverting input terminal of the differential amplifier to a fourth reference voltage source having a reference voltage higher than a reference voltage of the third reference voltage source during the charging period, and coupling the noninverting input terminal to a point of coupling 2 pieces of the resistor elements during the boosting period.

According to the DC/DC converter circuit described above, the voltage control resistor element is set to a high impedance during the charging period, and a voltage of an output of the circuit is made to rise by lowering an impedance of the voltage control resistor element by taking time in accordance with a transient response function of the differential amplifier without abruptly making the voltage rise immediately after shifting from the charging period to the boosting period. Therefore, the polarity inverting voltage or the rising voltage inherent to the charging pump circuit of exceeding the output setting voltage is not applied to the switch in the charging pump coupled to the output, and the withstand voltage of a transistor of making the switch can be reduced. Therefore, an area over LSI is smaller than that of a transistor having a high withstand voltage, a fabricating step is inconsiderable, and therefore, a fabricating cost is reduced. Further, an abnormal operation, a damage or the like of a load can be prevented since overshooting is not brought about at the output.

A detailed explanation will be given in accordance with embodiments in reference to the drawings as follows.

### First Embodiment

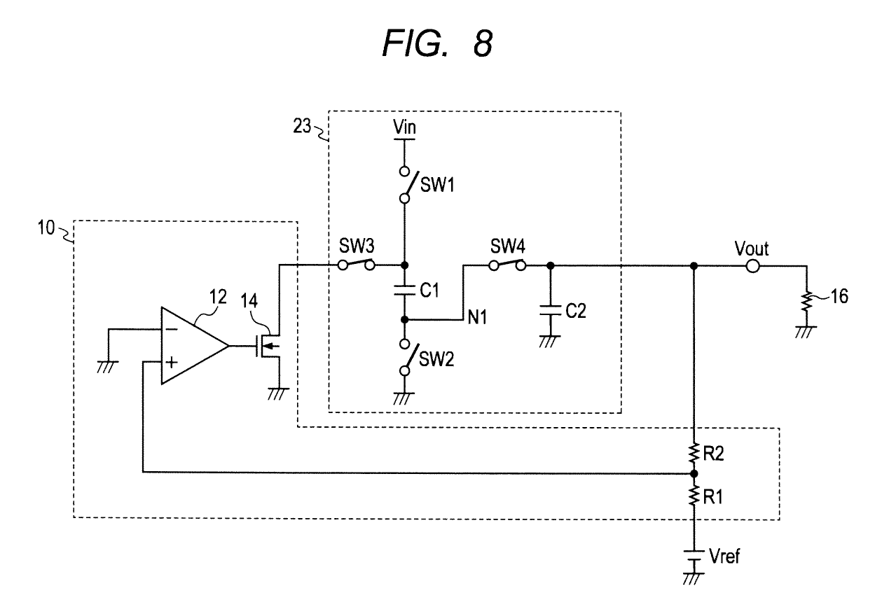

FIG. 1 is a circuit diagram of a DC/DC converter circuit according to a first embodiment of the present invention. The DC/DC converter circuit of the first embodiment is configured with a voltage inverting type. In FIG. 1, notations the same as those of FIG. 8 designate the same objects, and an explanation thereof will be omitted. Further, in FIG. 1 and FIG. 8, a differential amplifier AMP1 and the operational amplifier 12, a voltage control resistor element MN1 and the MOSFET14, a reference voltage Vref1 and the reference voltage Vref, and a load R3 and the load circuit 16 are respectively the same.

In FIG. 1, a charging pump circuit 21 is configured by deleting the switch SW3 in the charging pump circuit 23 of FIG. 8. A point of coupling the switch SW4 at an end of an output of the charging pump circuit 21 and the capacitor C2 is coupled to the output Vout and the load R3. The resistor R1 and the resistor R2 are coupled in series between the output Vout and the reference voltage Vref1, the reference voltage Vref1 is inputted to one end of the resistor R1, and other end thereof is coupled to a noninverting input terminal of the differential amplifier AMP1. The output voltage Vout is inputted to one end of the resistor R2, and other end thereof is coupled to the noninverting input terminal of the differential amplifier AMP1. An output terminal of the differential amplifier AMP1 is coupled to a gate terminal of the voltage control resistor element MN1 which is an NMOSFET. The voltage control resistor element MN1 is coupled between a point of coupling the switch SW1 at an end of an input of the charging pump circuit 21 and the capacitor cl and the ground (GND). An inverting input terminal of the differential amplifier AMP1 is coupled to switches SW5 and SW6 for respectively switching to GND and a reference voltage Vref2 which is a voltage higher than the reference voltage Vref1.

The DC/DC converter circuit configured in this way brings an output terminal of the differential amplifier AMP1 to a low level by coupling the reference voltage Vref2 having the voltage higher than the reference voltage Vref1 to the inverting input terminal of the differential amplifier AMP1 by making the switch SW5 OFF, and making the switch SW6 ON during the charging period. Therefore, the voltage control resistor element MN1 is set to an OFF state (high resistance).

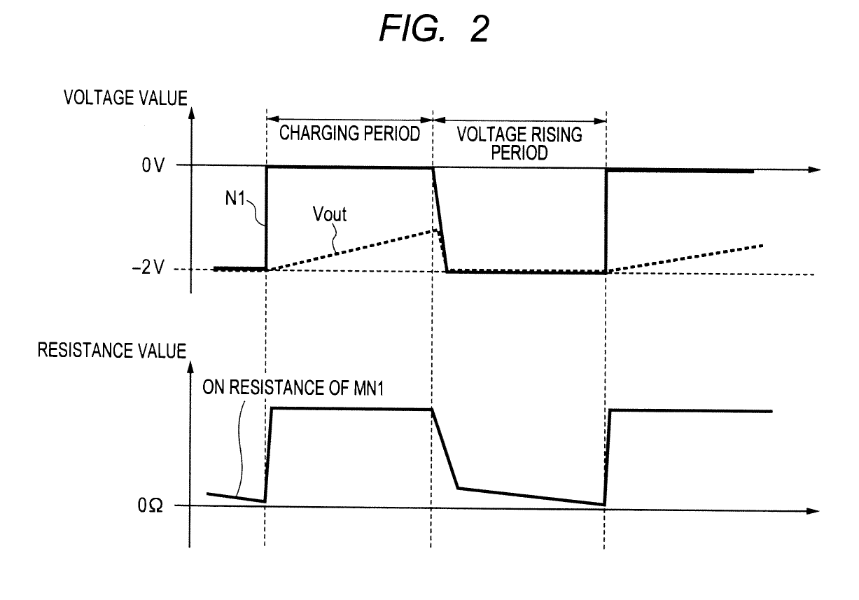

Next, a detailed explanation will be given of an operation of the DC/DC converter circuit according to the first embodiment. FIG. 2 shows waveforms showing changes in the output voltage Vout, a voltage at the point N1 of coupling the switch SW2 and the capacitor C1, and an impedance (resistance value) of the voltage control resistor element MN1 during the charging period and the boosting period of the DC/DC converter circuit according to the first embodiment. Here, a case of setting respective constants to values described below is shown as an example.

### R1=1 MΩ

### R2=2 MΩ

### VDD=3 V

### Vref1=1 V

### Vref21=2 V

### Vout=−1×Vref1×R2/R1=−2 V

The operation of the DC/DC converter circuit will be explained in a case where the output voltage Vout is shifted from the boosting period to the charging period by a value of −2 V which is the set voltage.

First, during the charging period, a power source voltage VDD is charged to the capacitor C1 by making the switches SW1 and SW2 ON. Further, a feedback loop is cut by making the switch SW4 OFF and the inverting input terminal of the differential amplifier AMP1 is switched from GND to the reference voltage Vref2 by making the switch SW5 OFF and making the switch SW6 ON. A voltage accumulated in the capacitor C2 is discharged by the load R3, and therefore, the output voltage Vout rises from −2 V which is the set voltage. In this case, the inverting input terminal of the differential amplifier AMP1 is coupled with Vref2 higher than the reference voltage Vref1, and therefore, the output voltage of the differential amplifier AMP1 is lowered, and the voltage control resistor element MN1 is brought into an OFF state (high resistance value).

Next, when shifted to the boosting period, the inverting input terminal of the differential amplifier AMP1 is coupled to GND by making the switch SW5 ON and making the switch SW6 OFF. Further, a voltage of adding a voltage at a point of coupling the switch SW and the capacitor C1 to a voltage of inverting the power source voltage VDD accumulated at the capacitor C1 is going to be charged to the capacitor C2 by making the switches SW1, and SW2 OFF and making the switch SW4 ON. At this occasion, immediately after shifting from the charging period to the boosting period, a transient response speed of the differential amplifier AMP1 is slow, and therefore, the output voltage is low, the voltage control resistor element MN1 is brought into the OFF state (high resistance value), and therefore, the state is the same as that of cutting the voltage control resistor element MN1. Therefore, the capacitor C2 is not charged, the voltage at the point N1 of coupling the switch SW2 and the capacitor C1 is determined by the output voltage Vout, and becomes a voltage the same as the output voltage Vout through the switch SW4. Further, a potential of a point of coupling the switch SW1 and the capacitor C1 immediately after shifting from the charging period to the boosting period becomes the potential of Vout +VDD of adding the power source VDD voltage accumulated at the capacitor C1 to the voltage of the output Vout.

During the boosting period thereafter, in order to control the output voltage Vout which rises more than the set voltage, the differential amplifier AMP1 lowers the impedance of the voltage control resistor element MN1 by making the output voltage of the differential amplifier AMP1 rise in accordance with the transient response function. Further, the output voltage Vout is lowered to coincide with the set voltage by lowering the potential at the point of coupling the switch SW1 and the capacitor C1. At this occasion, the transient response speed of the differential amplifier AMP1 is slow, and therefore, the output of the differential amplifier AMP1 rises gradually by taking time in accordance with the transient response function of the differential amplifier AMP1. Therefore, also the output voltage Vout falls gradually by taking the same time, and stops falling by reaching the set voltage.

As described above, the DC/DC converter circuit of the embodiment controls the voltage control resistor element MN1 to the high impedance during the charging period. Therefore, the capacitor C2 is not charged abruptly in switching from the charging period to the boosting period, and a voltage of −1×VDD which is the polarity inverting voltage inherent to the charging pump circuit 21 is not generated. Thereafter, the capacitor C2 is charged by lowering the impedance of the voltage control resistor element MN1 gradually by taking time in accordance with the transient response function of the differential amplifier AMP1. Therefore, a voltage exceeding the set voltage shown in Equation (1) is not generated at the switches SW2 and SW4 coupled to the output Vout at every time of immediately after switching from the charging period to the boosting period. Therefore, the switches SW2 and SW4 coupled to the output Vout can be designed by elements having a withstand voltage of the set voltage shown in Equation (1) lower than −1×VDD which is the polarity inverting voltage inherent to the charging pump circuit 21.

### Second Embodiment

FIG. 3 is a circuit diagram of a DC/DC converter circuit according to a second embodiment of the present invention. In FIG. 3, notations the same as those of FIG. 1 designate the same objects, and an explanation thereof will be omitted. Points of changing the DC/DC converter circuit according to the second embodiment from that of the first embodiment are as follows:

(1) The differential amplifier AMP1 is changed to a differential amplifier AMP2 having a terminal (hereinafter, referred to as output control end 34) of controlling a gate terminal of an output transistor.
(2) The output control end 34 is coupled to the power source VDD by a switch SW7.
(3) At an inverting input terminal of the differential amplifier AMP2, the inverting input terminal is coupled to the ground by deleting the switches SW5 and SW6.

FIG. 4 is a circuit diagram showing an example of the differential amplifier AMP2 used in the DC/DC converter circuit according to the second embodiment. In FIG. 4, the differential amplifier AMP2 is configured by a differential circuit 31, a phase correcting circuit 32 as a countermeasure against oscillation, an output transistor MN2, a current source 33 for output pull up, and an output control terminal 34. The differential amplifier AMP2 uses an NMOSFET for the output transistor MN2, and a gate terminal of the output transistor MN2 can input a signal from outside through the output control terminal 34.

A basic operation of the DC/DC converter circuit according to the second embodiment is the same as that of the first embodiment, and therefore, an explanation thereof will be omitted. A difference therebetween resides in that the voltage control resistor element MN1 is brought into the OFF state (high resistance value) by lowering an output voltage of the differential amplifier AMP2 by providing the power source voltage VDD to the gate of the output transistor MN2 at inside of the differential amplifier AMP2 by making the switch SW7 ON during the charging period.

According to the DC/DC converter circuit, similar to the first embodiment, the switches SW2 and SW4 coupled to the output Vout can be designed by elements having a withstand voltage of the set voltage of Equation (1) lower than −1×VDD which is the polarity inverting voltage inherent to the charging pump circuit 21. Further, also the overshooting of the output voltage Vout causing an abnormal operation, a damage or the like of the load R3 is not brought about.

### Third Embodiment

FIG. 5 is a circuit diagram of a DC/DC converter circuit according to a third embodiment of the present invention. The DC/DC converter circuit according to the third embodiment is configured with a voltage rising type, and a voltage control resistor element MP1 is brought into an OFF state (high resistance value) by grounding the inverting input terminal of the differential amplifier AMP1 during the charging period.

Points of changing the DC/DC converter circuit according to the third embodiment from that of the first embodiment are as follows.

(1) The voltage control resistor element MN1 is changed to the voltage control resistor element MP1, and one end (source) which has been grounded is changed to be coupled to the power source VDD.
(2) The charging pump circuit 21 of the voltage inverting type is changed to a charging pump circuit 22 of the voltage rising type. Further, the charging pump circuit 22 is configured as follows.

A switch SW11 and a switch SW12 are respectively coupled to both ends of a capacitor C11, the switch SW11 is coupled to the power source VDD, and the switch SW12 are coupled to the ground potential. A point of coupling the capacitor C11 and the switch SW12 is coupled to the other end of the voltage control resistor element MP1, and a switch SW14 is inserted between the capacitors C11 and C12. Other end of the capacitor C12 is grounded.

(3) Vref1 is deleted, and GND and the resistor R1 are coupled as a substitute therefor.
(4) As an input of the inverting input terminal of the differential amplifier MP1, the switches SW5 and SW6 are deleted. And the input is connected to switches SW15 and SW16 for respectively switching a reference voltage Vref3 and GND as a substitute therefor.

The DC/DC converter circuit according to the first embodiment is a circuit including the charging pump circuit 21 of carrying out −1 time of voltage rising. In contrast thereto, the DC/DC converter circuit according to the third embodiment is a circuit including the charging pump circuit 22 of carrying out 2 times of voltage rising, and a basic operation thereof is the same as that of the charging pump circuit 21.

The voltage generated at the output Vout is divided by the resistors R1 and R2 and conducted to the noninverting input terminal of the differential amplifier AMP1 the inverting input terminal of which is coupled with the reference voltage Vref3. During the boosting period, the voltage rising type DC/DC converter circuit is configured with a feedback loop, and the differential amplifier AMP1 sets the output voltage Vout to a value shown in Equation (2) described below by changing a potential at a point of coupling the switch SW12 and the capacitor C11 by the voltage control resistor element MP1.

Vout=Vref3×(R1+R2)/R1 . . . Equation (2)

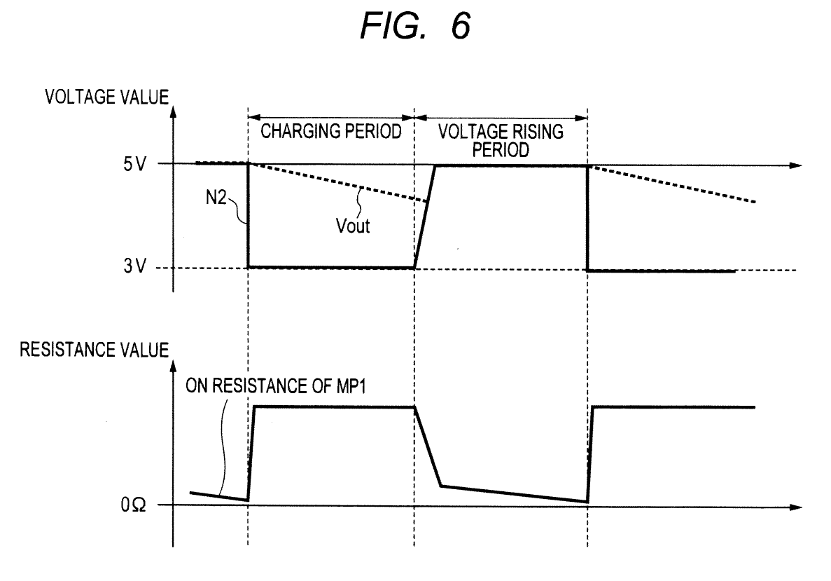

Next, a detailed explanation will be given of the operation of the DC/DC converter circuit according to the third embodiment. FIG. 6 shows waveforms showing changes in the output voltage Vout, a voltage at a point N2 of coupling the switch SW1 and the capacitor C11, and an impedance (resistance value) of the voltage control resistor element MP1 during the charging period and the boosting period of the DC/DC converter circuit according to the third embodiment. Here, an example of a case of setting respective constants to values described below is shown.

### R1=1 MΩ

### R2=4 MΩ

### VDD=3 V

### Vref3=1 V

### Vout=Vref3×(R1+R2)/R1=5 V

An operation of the DC/DC converter circuit according to the third embodiment will be explained in a case where the output voltage is shifted from the boosting period to the charging period by a value of 5 V which is the set voltage.

First, during the charging period, the power source voltage VDD is charged to the capacitor C11 by making the switches SW11 and SW12 ON. Further, the feedback loop is cut by making the switch SW14 OFF, and the input of the inverting input terminal is switched from the reference voltage Vref3 to GND by making the switch SW15 OFF and making the switch SW16 ON. The voltage accumulated at a capacitor C12 is discharged by the load R3, and therefore, the output voltage Vout is lowered from 5 V which is the set voltage. In this case, the inverting input terminal of the differential amplifier MP1 is coupled with GND which is sufficiently lower than the voltage dividing the output voltage Vout by the resistors R1 and R2, and therefore, the output voltage of the differential amplifier AMP1 rises and the voltage control resistor element AMP1 is brought into an OFF state (high resistance).

Next, when shifted to the boosting period, the voltage of the inverting input terminal of the differential amplifier AMP1 is made to be the reference voltage Vref3 by making the switch SW15 ON and making the switch SW16 OFF. Further, a voltage of adding the voltage at the point of coupling the switch SW12 and the capacitor C11 to the power source voltage VDD accumulated at the capacitor C11 is going to be charged to the capacitor C12. In this case, immediately after shifting from the charging period to the boosting period, the output voltage of the differential amplifier MP1 is high, the voltage control resistor element MP1 has the high resistance, and therefore, the state is the same as that of being cut. Therefore, the capacitor C12 is not charged, the voltage at the point N2 of coupling the switch SW11 and the capacitor C11 is determined by the output voltage Vout, and becomes a voltage the same as that of the output Vout through the switch SW14. Further, a potential at the point of coupling the switch SW12 and the capacitor C11 becomes a potential of Vout-VDD of subtracting the power source VDD voltage accumulated at the capacitor C11 from the voltage of the output Vout.

During the boosting period thereafter, in order to control the output voltage Vout which becomes lower than the set voltage, the differential amplifier AMP1 makes the output voltage Vout rise by lowering the resistance value of the voltage control resistor element AMP1 by lowering the output voltage of the differential amplifier AMP1, and making the potential at the point of coupling the switch SW12 and the capacitor C11 rise to coincide with the set voltage. In this case, since the transient response speed of the differential amplifier MP1 is slow, the output voltage of the differential amplifier AMP1 gradually falls by taking time in accordance with the transient response function of the differential amplifier AMP1, and therefore, also the output voltage Vout rises gradually by taking the same time, and stops rising by reaching the set voltage.

In this way, the DC/DC converter circuit according to the third embodiment sets the impedance of the voltage control resistor element MP1 in correspondence with the voltage control resistor element MN1 according to the first embodiment to the high resistance during the charging period similar to the first embodiment. Therefore, the switches SW11 and SW14 coupled to the output voltage Vout can be designed by elements having a withstand voltage of the set voltage shown in Equation (2) which is lower than 2×VDD voltage which is the rising voltage inherent to the charging pump circuit 22. Further, also the overshooting of the output causing an abnormal operation, a damage or the like of the load R3 is not brought about.

### Fourth Embodiment

FIG. 7 is a circuit diagram of a DC/DC converter circuit according to a fourth embodiment of the present invention. In FIG. 7, notations the same as those of FIG. 5 designate the same objects, and an explanation thereof will be omitted. The DC/DC converter circuit according to the fourth embodiment is configured with the voltage rising type, and the voltage control resistor element MP1 is set to the high resistance by coupling the inverting input terminal of the differential amplifier AMP1 to a reference voltage Vref4 set to a voltage higher than the reference voltage Vref3 coupled to the noninverting input terminal of the differential amplifier MP1 during the charging period.

Points of changing the DC/DC converter circuit according to the fourth embodiment from that of the third embodiment are as follows.

(1) The inverting input terminal of the differential amplifier MP1 is coupled with the reference voltage Vref3 as a substitute for deleting the switches SW15 and SW16.
(2) The noninverting input terminal of the differential amplifier AMP1 is coupled to switches SW17 and SW18 for respectively switching the voltage at the point of coupling the resistor R1 and the resistor R2 and the reference voltage Vref4 set to a voltage higher than the reference voltage Vref3 as a substitute for being directly coupled to the point of coupling the resistor R1 and the resistor R2.

The basic operation of the DC/DC converter circuit according to the fourth embodiment is the same as that of the third embodiment, and therefore, an explanation thereof will be omitted. A difference therebetween resides in that the voltage control resistor element MP1 is brought into an OFF state (high resistance) by making the output voltage of the differential amplifier AMP1 rise by coupling the inverting input terminal of the differential amplifier AMP1 to the reference voltage Vref4 set to a voltage higher than the reference voltage Vref3 coupled to the noninverting input terminal of the differential amplifier AMP1 by making the switch SW17 OFF and making the switch SW18 ON during the charging period.

The DC/DC converter circuit according to the fourth embodiment sets the resistance value of the voltage control resistor element MP1 to the high resistance during the charging period similar to the third embodiment. Therefore, the switches SW11 and SW14 coupled to the output Vout can be designed by elements having a withstand voltage of the set voltage of Equation (2) which is lower than 2×VDD voltage which is the voltage rising voltage inherent to the charging pump circuit 22. Further, also the overshooting of the output causing an abnormal operation, a damage or the like of the load R3 is not brought about.

In the above-described embodiments, an explanation has been given of the DC/DC converter circuits including the charging pump circuit of −1 time or 2 times. However, the present invention is not limited to these, but can be applied also to DC/DC converter circuits including charging pump circuits of generating voltages of N times which have been known in the background arts of ..., −2 times, −1 time, 2 times, 3 times, 4 times, . . . According to the DC/DC converter circuit, a voltage of N times of the power source VDD which is the rising voltage inherent to the charging pump circuit is prevented from being generated at the output Vout, the output Vout is restrained to the set voltage, and therefore, the overshooting can be prevented.

Further, respective disclosures of patent documents or the like described above are incorporated to the present document by citation. Within a framework of all of the disclosure (including claims) of the present invention, embodiments or examples can be changed or adjusted based on the basic technical thought. Further, within the framework of the claim(s) of the present invention, various combinations or selections of various disclosed elements can be carried out. That is, the present invention naturally includes various modifications and corrections which would be carried out by the skilled person in accordance with all of the disclosure including the claim(s) and the technical thought.

What is claimed is:

1. A DC/DC converter circuit comprising:
a charging pump circuit that discharges an electric charge charged during a charging period to a load during a boosting period; and
an amplifier and a voltage control resistor element arranged in a feedback loop by being configured with the feedback loop of feeding back an output voltage such that the output voltage of the charging pump circuit is made to be a predetermined value during the boosting period;
wherein the voltage control resistor element is controlled by the amplifier and sets to a control resistance value enabling to control the charging pump circuit during the boosting period; and
wherein the amplifier controls the voltage control resistor element such that the voltage control resistor element is brought into an OFF state during the charging period, and a resistance value of the voltage control resistor element is lowered to the control resistance value immediately after shifting from the charging period to the boosting period.

2. The DC/DC converter circuit according to claim 1,
wherein the voltage control resistor element is an MOSFET, and
wherein the amplifier couples an output terminal to a gate of the MOSFET, and is configured such that the output terminal can be set to a predetermined potential to bring the MOSFET into an OFF state during the charging period.

3. The DC/DC converter circuit according to claim 2, wherein the amplifier is a differential amplifier, and is configured such that a potential difference is provided between a converting input terminal and a nonconverting input terminal of the differential amplifier during the charging period.

4. The DC/DC converter circuit according to claim 3,
wherein the MOSFET is an NMOSFET of grounding a source thereof and coupling a drain thereof to the charging pump circuit;
wherein two pieces of resistor elements of coupling the load and a first reference voltage source in a serial mode are provided;
wherein the noninverting input terminal of the differential amplifier is coupled to a point of coupling two pieces of the resistor elements; and
wherein a switching circuit coupling the inverting input terminal of the differential amplifier to a second reference voltage source having a reference voltage higher than a reference voltage of the first reference voltage source during the charging period, and grounding the inverting input terminal during the boosting period is provided.

5. The DC/DC converter circuit according to claim 2,
wherein the MOSFET is an NMOSFET grounding a source thereof and coupling a drain thereof to the charging pump circuit;
wherein two pieces of resistor elements of coupling the load and a first reference voltage source in a serial mode are provided;
wherein the amplifier is a differential amplifier;
wherein a noninverting input terminal of the differential amplifier is coupled to a point of coupling two pieces of resistor elements;
wherein an inverting input terminal of the differential amplifier is grounded; and
wherein a switch circuit of making an output stage NMOS transistor of the differential amplifier ON such that the NMOSFET is brought into an OFF state during the charging period is provided.

6. The DC/DC converter circuit according to claim 3,
wherein the MOSFET is a PMOSFET coupling a source thereof to a power source, and coupling a drain thereof to the charging pump circuit;
wherein two pieces of resistor elements of coupling the load and the ground in a serial mode are provided;
wherein a noninverting input terminal of the differential amplifier is coupled to a point of coupling two pieces of the resistor elements; and
wherein a switching circuit of grounding an inverting input terminal of the differential amplifier during the charging period, and coupling the inverting input terminal to a third reference voltage source during the boosting period is provided.

7. The DC/DC converter circuit according to claim 3, wherein the MOSFET is a PMOSFET of coupling a source thereof to a power source and coupling a drain thereof to the charging pump circuit;
wherein two pieces of resistor elements of coupling the load and the ground in a serial mode are provided;
wherein an inverting input terminal of the differential amplifier is coupled to a third reference voltage source; and
wherein a switching circuit of coupling a noninverting input terminal of the differential amplifier to a fourth reference voltage source having a reference voltage higher than a reference voltage of the third reference voltage source during the charging period, and coupling the noninverting input terminal to a point of coupling two pieces of the resistor elements during the boosting period is provided.
